(19) United States
(12) Patent Application Publication
(10) Pub. No.: US 2021/0041946 A1
(43) Pub. Date: Feb. 11, 2021

(54) Video Communications System with Aligned Eye Contact

(71) Applicants: Luc De Backer, Buggenhout (BE); Peter McDuffie White, Bonham, TX (US)

(72) Inventors: Luc De Backer, Buggenhout (BE); Peter McDuffie White, Bonham, TX (US)

(21) Appl. No.: 16/913,985

(22) Filed: Jun. 26, 2020

Related U.S. Application Data
(60) Provisional application No. 62/884,269, filed on Aug. 8, 2019.

(51) Int. Cl. G06F 3/01; G03B 21/10; G03B 21/28; H04N 9/75; H04N 7/15; H04N 5/222

(52) U.S. Cl. CPC G06F 3/013; G03B 21/10; H04N 5/2222; H04N 9/75; H04N 7/15; G03B 21/28

(57) ABSTRACT

A video communication system to transmit an image of a presenter to appear displayed with eye contact at a location of an audience. The transmission system may comprise a camera positioned at the height of the eye level of the presenter with a direct view of the presenter through a semi-reflective mirror. The presenter may view in a line of sight through the semi-reflective mirror toward the camera to see a double reflection of an image display device with a live video of an audience as a reflection off the semi-reflective mirror and a secondary reflection off a mirror to display the image in a vertical orientation.

### TECHNICAL FIELD

The present invention relates to communications systems incorporating a video image capture device with alignment for perceived eye contact using a double mirror configuration to correctly orient a non-reversed double reflection of an image display device.

### BACKGROUND

There has become a need for improved methods for capturing video of presenters on camera with a perceived eye contact. Teleprompters have commonly been used in television production, but these are dependent on reflecting an image of an image display monitor. The reflected image is a mirror image, which is reversed. This reversed image requires special electronic equipment or custom monitors to reverse the displayed image to the correct orientation. There is a need for a system that could use a standard monitor without the extra cost of specialist capability to reverse the displayed image.

### PRIOR ART CONFIGURATIONS

Prior configurations have used a “teleprompter”, which has a video camera positioned to directly view the displayed image through a semi-reflective mirror. The semi-reflective mirror is angled at approximately 45 degrees to reflect an image display device. The reflected image appears superimposed behind the semi-reflective mirror in line with the camera. When a presenter on camera is looking at the visual content appearing on the reflected image of the image display device in the teleprompter, the presenter will be looking toward the camera. The captured image of the presenter will be broadcast or transmitted to a location where the displayed image of the presenter will appear to be looking directly toward the audience for the impression of eye contact.

However, this approach of using a single reflection produces a “mirror image”, which is reversed horizontally to appear backwards. In order to achieve a correct orientation of the displayed image, it is necessary to reverse the image on the image display device in the teleprompter. This requires the additional capability of electronically reversing the displayed image.

The prior art of FIG. 1 shows a user 1 looking forward at eye level along a line of sight 10 through a semi-reflective mirror 2 to view a reflected image 7 of an image display device 6. Within this line of sight 10 a camera 3 is positioned with a field of view forward toward the observation zone of user 1. The camera 3 will be exposed to a reflection off the semi-reflective mirror 2 of a black panel 15. Since the black panel 15 will not expose the camera 3 to additional light in the image, the camera 3 will primarily capture an image of the user 1. It is noted that the reflected image 7 will be a mirror image off the semi-reflective mirror 2 to appear reversed.

The prior art of FIG. 2 shows a user 1 looking forward on an eye level line of sight 10 through a semi-reflective mirror 2 to directly view an image display device 6. A camera 3 is positioned below the semi-reflective mirror 2 and views upwards along a line of sight 11 to align with a reflected view of the eye level line of sight 10. A black panel 16 is positioned below the semi-reflective mirror 2 to essentially eliminate light reflecting in the view of the user 1 when looking toward the image display device 6. The camera 3 is positioned below a black panel 16 to view through an opening 18. The camera 3 will view through the semi-reflective mirror 2 toward a black panel 15. Since the black panel 15 will not substantially expose the camera 3 to light, the camera will primarily be exposed with the image reflected off the semi-reflective mirror 2 toward the user 1. It is noted that the camera 3 will capture a reflected view of the user 1 that will need to be horizontally reversed for the correct orientation when viewed at the receiving location.

The prior art of FIG. 2 has two disadvantages. Firstly, not all cameras have the function of flipping the mirror image. Secondly, the camera view reflected off the semi-reflective mirror 2 is not as desirable as a direct view through a semi-reflective mirror due to dust and smudges on the front surface and loss of light in the reflected image.

The prior art of FIG. 3 is the same configuration as FIG. 2 except that the camera 3 is positioned to view forward along a line of sight 12 toward a second mirror 8. In this configuration the camera orientation is correctly captured resulting from the double reflection. The double reflection of the camera view does achieve the objective of capturing a view in the correct orientation, however there is a reduction of quality in the camera image resulting from the loss of light and potential for degradation of the image from the two reflective surfaces.

The prior art of FIG. 4 is the same configuration as FIG. 2 except for the semi-reflective mirror 2 orientation to reflect the camera 3 positioned above.

The prior art of FIG. 5 is the same configuration as FIG. 4 except that a zoom camera 4 is positioned for viewing forward along a line of sight 12 toward a second mirror 8 angled for a reflection downwards to a semi-reflective mirror.

The prior art of FIG. 6 is the same configuration as FIG. 5 except a webcam 5 is used to capture the video image.

Hence, there is a need for an improved system that addresses the shortcomings of the prior art mentioned above.

### SUMMARY OF THE INVENTION

The problems and needs outlined above are addressed by embodiments. In accordance with one aspect there is a video transmission system in a configuration that does not require either the camera view or the user's view of the image display device to be reversed. This is achieved by the position of the camera at eye level to view the user directly through a semi-reflective mirror and the user to view the image display device as a reflection off the semi-reflective mirror and a second reflection off a secondary mirror. Furthermore, the invention positions the reflected imagery of the image display device into a location at eye level that achieves a perceived eye contact when displayed as a recorded or transmitted image.

### BRIEF DESCRIPTION OF THE DRAWINGS

The above features of these embodiments will be more clearly understood from consideration of the following descriptions in connection with accompanying drawings in which:

FIG. 1 illustrates a prior art configuration displaying a teleprompter with a camera viewing through a semi-reflective mirror with a reflected image display device;

FIG. 2 illustrates a prior art configuration displaying a direct view of an image display device with a semi-reflective mirror reflecting a camera positioned below;

FIG. 3 illustrates a prior art configuration similar to FIG. 2 with a second mirror in the camera line of sight;

FIG. 4 illustrates a prior art configuration similar to FIG. 2 with the semi-reflective mirror angled to reflect a camera positioned above;

FIG. 5 illustrates a prior art configuration similar to FIG. 4 with a second mirror in the line of sight of a zoom camera;

FIG. 6 illustrates a prior art configuration similar to FIG. 5 with a webcam;

FIG. 7 illustrates a view of an image display device that is reflected in a semi-reflective mirror and reflected in a second mirror;

FIG. 8 illustrates a camera directly viewing a user through a semi-reflective mirror;

FIG. 9 illustrates a user's view of a double reflection of an image display device and a lower view of a data monitor;

FIG. 10 illustrates a perspective cutaway view of an embodiment of the present invention;

FIG. 11 illustrates a perspective view of the embodiment of the present invention within an enclosure;

FIG. 12 illustrates a configuration of a camera view of a user at eye level with a configuration of a semi-reflective mirror aligned at 45 degrees and a secondary mirror aligned at 45 degrees;

FIG. 13 illustrates a configuration of a camera view of a user at eye level with a configuration of a semi-reflective mirror aligned at 50 degrees and a secondary mirror aligned at 50 degrees;

FIG. 14 illustrates a configuration of a camera view of a user at eye level with a configuration of a semi-reflective mirror aligned at 55 degrees and a secondary mirror aligned at 55 degrees;

FIG. 15 illustrates a configuration of a camera view of a user at eye level with a configuration of a semi-reflective mirror aligned at 55 degrees and a secondary mirror aligned at 60 degrees with an image display device aligned at 80 degrees;

FIG. 16 illustrates an embodiment of the eye contact transmission system mounted on a wall;

FIG. 17 illustrates an embodiment of FIG. 16 placed on a horizontal surface with the overhead black panel rotated to the angle of the semi-reflective mirror;

FIG. 18 illustrates an embodiment of FIG. 17 with the semi-reflective mirror folded inward to a vertical position;

FIG. 19 illustrates an embodiment of FIG. 18 with the second mirror folded inward to a vertical position;

FIG. 20 illustrates an embodiment of FIG. 19 with a supporting foot 29 rotated up to make the embodiment a flat and compact unit to be portable.

FIG. 21 illustrates an embodiment of the eye contact transmission system with a large image display device.

FIG. 22 illustrates an embodiment of the eye contact transmission system with optimized angles of the semi-reflective mirror, second mirror and image display device.

FIG. 23 illustrates an embodiment of the eye contact transmission system with an image display device providing the background behind the camera view of the user.

FIG. 24 illustrates an embodiment of the eye contact transmission system with a backlit panel providing the background behind the camera view of the user.

FIG. 25 illustrates an embodiment of the eye contact transmission system with a front lit panel providing the background behind the camera view of the user.

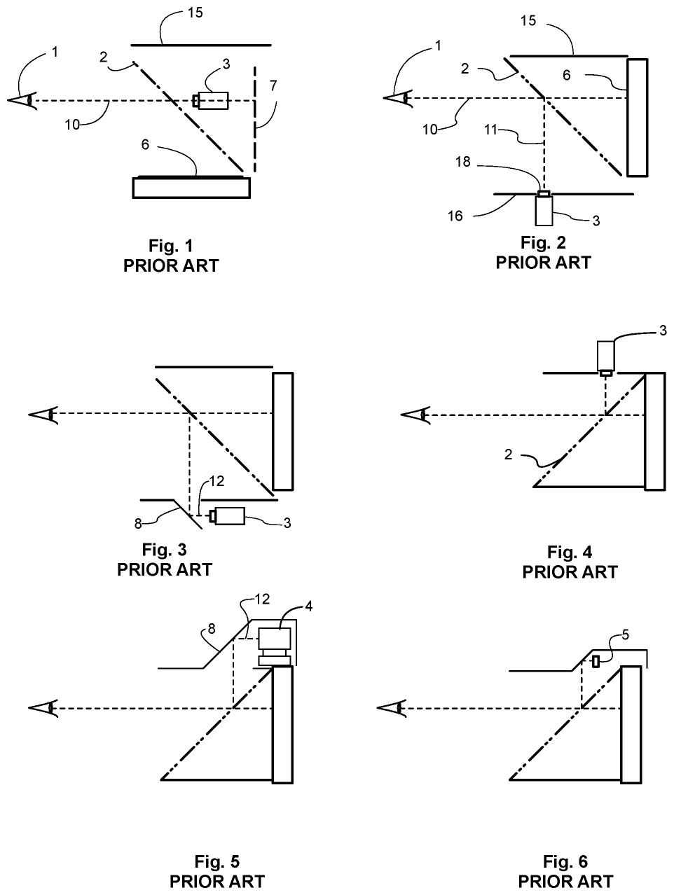

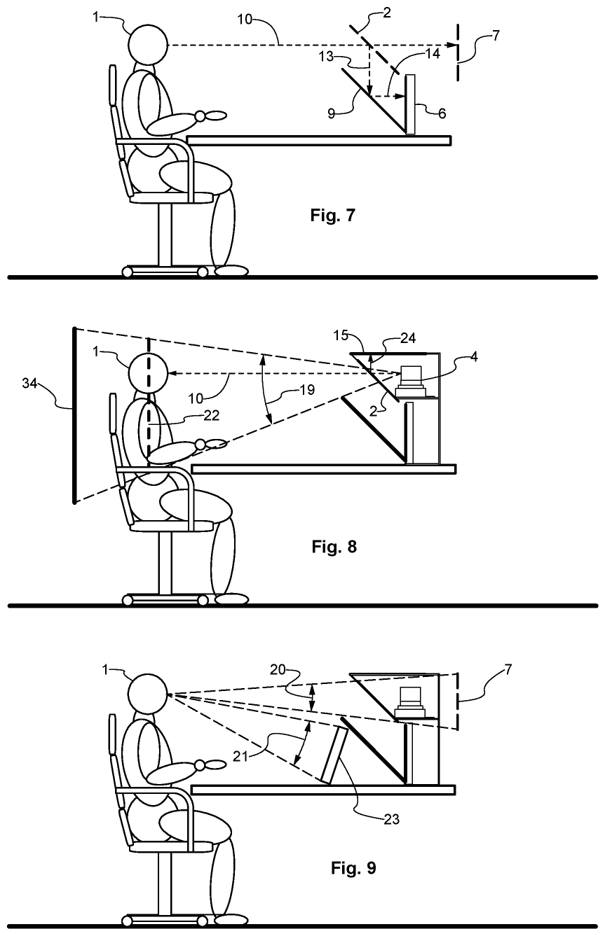

### DETAILED DESCRIPTION OF THE ILLUSTRATIVE EMBODIMENTS

Referring now to the drawings, wherein like reference numbers are used to designate like elements throughout the various views, as several embodiments are further described. The figures are not necessarily drawn to scale, and in some instances, the drawings have been exaggerated or simplified for illustrative purposes only. One of ordinary skill in the art will appreciate the many possible applications based on the following examples of possible embodiments.

FIG. 7 shows an embodiment with a user 1 viewing forward at eye level on a line of sight 10 to view through a semi-reflective mirror 2 to see an image 7 reflected in a semi-reflective mirror 2 along a line of sight 13 and a secondary mirror 9 reflecting an image display device 6 along a line of sight 14. The reflected image 7 appears in a vertical orientation as a non-reversed image due to a reversed image off the semi-reflective mirror 2 being reversed back to the correct orientation in the reflection off second mirror 9.

The semi-reflective mirror 2 may be a substrate that permits both transmittance and reflectance. The substrate may be glass, plastic, stretched film or other method for accomplishing the required transmittance and reflectance. The semi-reflective mirror 2 may comprise a reflective surface on the front facing the user 1 and an anti-reflective surface on the back.

The second mirror 9 may be a highly reflective surface of glass, plastic, stretched film or other material. The second mirror 9 may have the reflective surface on the back surface or on the front surface for optimal reflectance.

FIG. 8 shows a zoom camera 4 viewing a user 1 through a semi-reflective mirror 2 at an angle of view 19 along an eye level line of sight 10. The zoom camera 4 may be exposed to a reflection 24 off the semi-reflective mirror 2 of an overhead black panel 15. Since the black panel 15 will not add light to expose the image captured by the zoom camera 4, the image will primarily be of the user 1.

The zoom camera 4 may be replaced with a different video image capture device, such as a fixed focal length camera or webcam. The captured image from the zoom camera 4 may be transmitted to be displayed on an image display device at a receiving location in the correct orientation. In order to display the image of the user at life-size at the receiving location, the angle of view 19 may be set to achieve a specific height at the plane 22 of the middle of the user 1. In this manner the height of the plane 22 may be matched to the height of the image display device at the receiving location to display the user 1 at life-size. The camera view 19 may view a selected background 34 positioned behind the user 1.

The image on the image display device 6 may be an incoming video transmitted from a remote location showing a person, a group of people or an audience that may receive the transmitted image of the user 1 appearing to have eye contact. The video communication may transmit the user 1 to a receiving location for display while transmitting an image to be displayed on the image display device 6 in real time for two-way communication as a video conference. Alternatively, the video of the user 1 may be broadcast via television or Internet for viewing by audiences.

The image on the image display device may be text to be viewed by the user 1 to show the narrative for the user 1 to present. The embodiment of the present invention may perform functions typically associated with “teleprompters”.

FIG. 9 shows an angle of view 20 for the user 1 to see the reflected image 7. A second angle of view 21 may be positioned below to view a data monitor 23. The data monitor 23 may be an LCD screen, LED screen, electronic tablet or a secondary image display device.

FIG. 10 shows a cutaway perspective view of the embodiment 31 with zoom camera 4 behind a semi-reflective mirror 2 with a black panel 15 above. A second mirror 9 is in front of an image display device 6. A computer 32 is positioned within the cutaway perspective view of the embodiment 31. A plug strip 33 is provided for distribution of power to the pieces of electronic equipment. A light 30 is added to the embodiment 31.

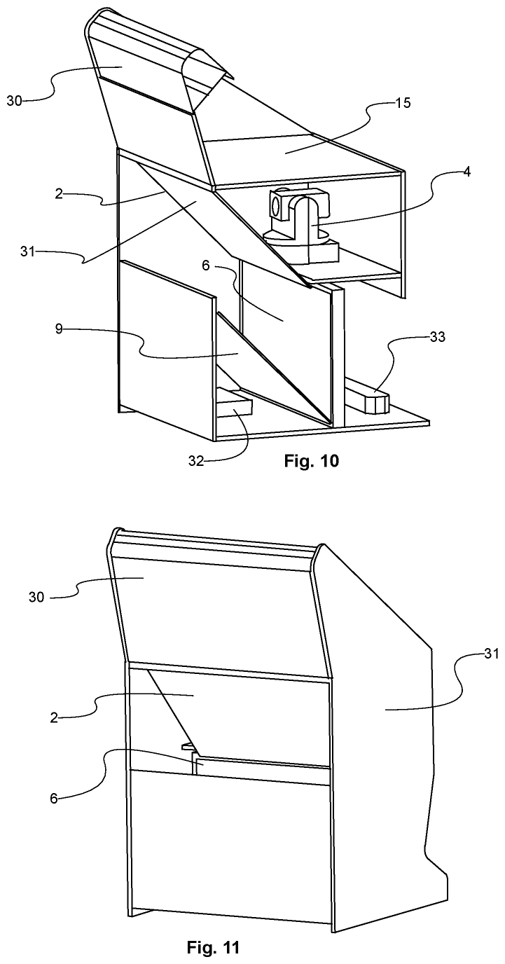

FIG. 11 shows the embodiment 31 with the sides covered. From the front the semi-reflective mirror 2 is within view. The image display device 6 is only partially within view. The overhead light 30 is at the top of the embodiment 31.

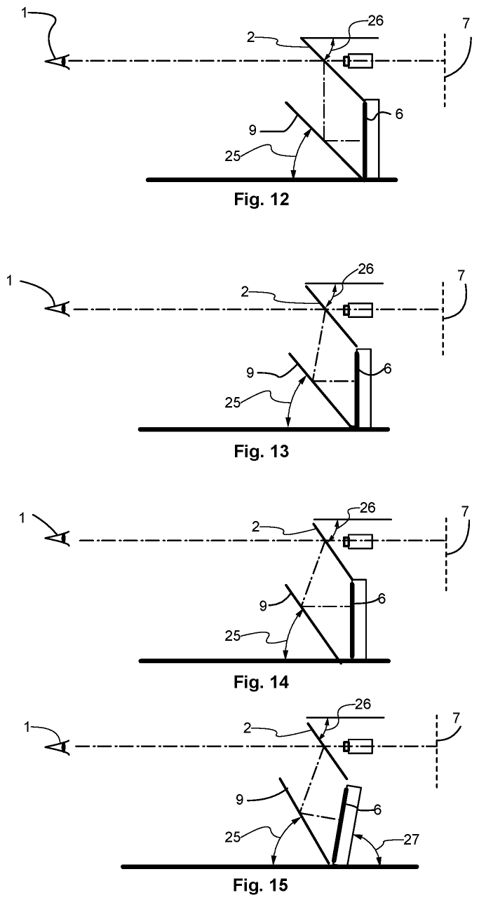

FIG. 12 shows an embodiment with the semi-reflective mirror 2 at an angle 26 of 45 degrees to a horizontal plane and the second mirror 9 at an angle 25 of 45 degrees to a horizontal plane to result in a vertical orientation of the reflected image 7. The image display device 6 is in a vertical orientation.

FIG. 13 shows an embodiment with the semi-reflective mirror 2 at an angle 26 of 50 degrees to a horizontal plane and the second mirror 9 at an angle 25 of 50 degrees to a horizontal plane to result in a vertical orientation of the reflected image 7. The image display device 6 is in a vertical orientation.

FIG. 14 shows an embodiment with the semi-reflective mirror 2 at an angle 26 of 55 degrees to a horizontal plane and the second mirror 9 at an angle 25 of 55 degrees to a horizontal plane to result in a vertical orientation of the reflected image 7. The image display device 6 is in a vertical orientation.

FIG. 15 shows an embodiment with the semi-reflective mirror 2 at an angle 26 of 55 degrees to a horizontal plane and the second mirror 9 at an angle 25 of 60 degrees to a horizontal plane to result in a vertical orientation of the reflected image 7. The image display device 6 is at an angle 27 of 80 degrees.

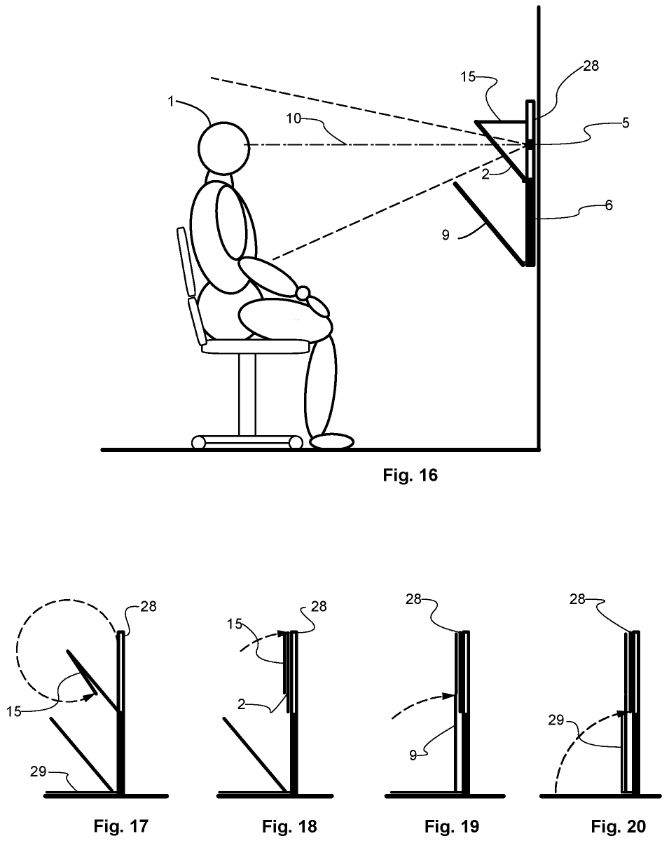

FIG. 16 shows an embodiment of the eye contact transmission system 28 mounted on a wall. The web camera 5 views the user 1 through a semi-reflective mirror 2 at an eye level line of sight 10. An overhead black panel 15 is positioned above the semi-reflective mirror 2. A second mirror 9 is positioned below the semi-reflective mirror 2. An image display device 6 may be thin, such as a depth of two inches or less, to make it possible for the entire transmission system 28 to be thin and compact. It may be possible for the transmission system 28 to be less than 3″ deep, when it is folded up to achieve minimal depth when mounted against a wall.

FIG. 17 shows the embodiment of FIG. 16 with the overhead black panel 15 rotated to the front of the semi-reflective mirror 2. The embodiment 28 may have a supporting foot 29 for placing the embodiment 28 on a horizontal surface.

FIG. 18 shows the embodiment of FIG. 17 with the black panel 15 covering the front of the semi-reflective mirror 2 as it is rotated upward to a vertical position.

FIG. 19 shows an embodiment of FIG. 18 with the second mirror 9 rotated upward to a vertical position.

FIG. 20 shows an embodiment of FIG. 19 with a foot 29 rotated up to make the transmission system 28 compact. The embodiment 28 could fit within a carrying case or be shipped in a relatively small equipment case. In this orientation the eye contact transmission system 28 can be folded up to a minimal depth when not in use.

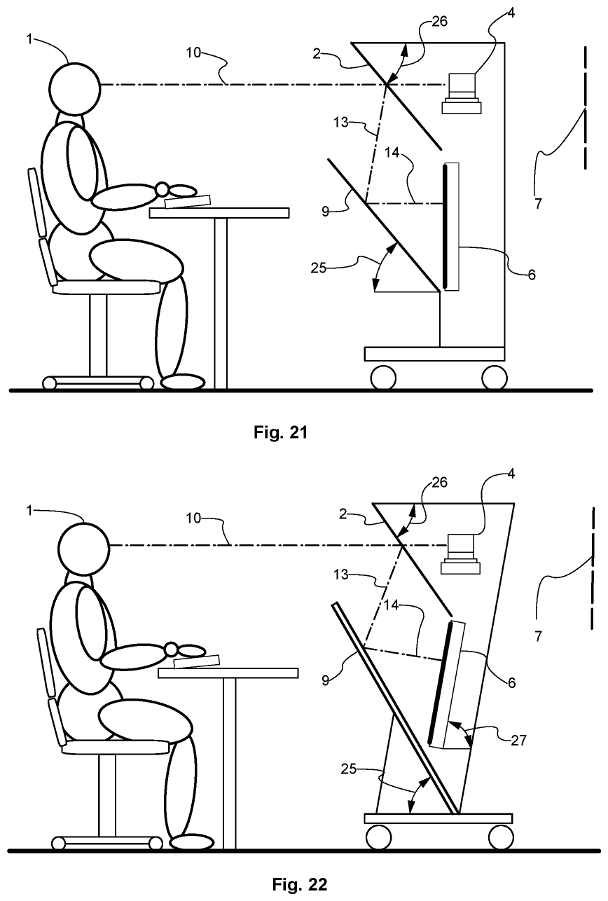

FIG. 21 shows an embodiment of the eye contact transmission system with a large monitor 6. The larger reflected image 7 provides a better view of the displayed video showing a remote location. The zoom camera 4 views through the semi-reflective mirror 2 along a line of sight 10 to align eye contact with the user 1. The semi-reflective mirror 2 may be aligned at an angle 26 to optimize viewing of the reflection along a line of sight 13 to the second mirror 9, which is aligned at an angle 25 to reflect the line of sight 14 to the image display device 6 resulting in a vertical orientation of a reflected image 7.

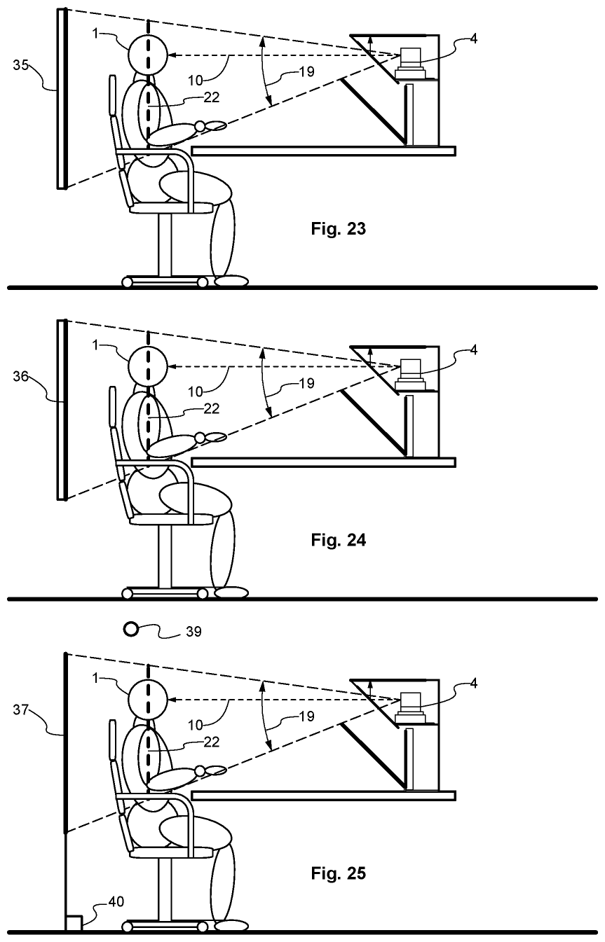

FIG. 22 shows an embodiment of the eye contact transmission system with a large monitor 6. The zoom camera 4 views through the semi-reflective mirror 2 along a line of sight 10 to align eye contact with the user 1. The semi-reflective mirror 2 may be aligned at a greater angle 26 to optimize viewing of the reflection along a line of sight 13 to the second mirror 9, which is aligned at an angle 25 to reflect the line of sight 14 to the image display device 6 at an angle 27 resulting in a vertical reflected image 7.

FIG. 23 shows a configuration of FIG. 8 with the addition of an image display device 35 positioned within the view 19 of the camera 4 with the eye level line of sight 10. The size of the image display device 35 is larger than the image plane 22 to accommodate the angle of view 19 as it enlarges behind the user 1. The image display device 35 may display a background image that will appear in the captured video image of the user 1. The image display device 35 may be a 65″ or larger monitor. This background image may be of a city view representing the location of the user 1, a photograph of a professional workplace, a live transmitted video of a relevant scene, a playback of a video setting with activity, a studio set representing a broadcasting center or other visual content.

FIG. 24 shows a configuration of FIG. 8 with an optional light panel 36 for illuminating a sheet of transparent material from behind. The photographic image or graphic may be printed on the transparent material, which may be viewed by the camera 4 within the angle of view 19 to appear as a background behind the user 1. Alternatively, the sheet of transparent material may be colored green to function as a green screen for a Chroma Key to replace the green area with selected video content to appear behind the user 1.

FIG. 25 shows a configuration of FIG. 8 with an optional panel 37 that is front lit to appear behind the user 1 from the angle of view 19 of the camera 4. The panel 37 may have a printed photographic image or graphic display to appear as a backdrop. Alternatively, the panel 37 may be green for a Chroma Key application. Lights 39 may be positioned above and/or to the sides of the panel 37 to evenly illuminate the surface of the panel 37. The panel may be a rigid surface held in position on a stand, fixed to a wall or hung from the ceiling. The panel 37 may be a screen that could roll up into an enclosure 40.

What is claimed is:

1. A video communications system for capturing the image of a presenter to have a perceived eye contact when displayed at a receiving location comprising:
A camera positioned at a height approximately at the eye level height of a presenter within an observation zone and angled with a field of view to capture the image of the said presenter within the observation zone;
A semi-reflective mirror positioned between the camera and the presenter in the observation zone and angled to reflect the area below said semi-reflective mirror as viewed by the presenter;
a light-absorbing panel positioned above said semi-reflective mirror and located in the reflected view of said camera;
a second mirror positioned below said semi-reflective mirror and within the reflected view of said presenter with said second mirror angled to reflect the area under said camera;
an image display device positioned below said camera and within the reflected view of said presenter as seen reflected off the semi-reflective mirror and as a second reflection off the second mirror;
The angles of the semi-reflected mirror, the second mirror and the image display device are set so that the resulting double reflection appears behind the semi-reflective mirror in the eye level line of sight with the camera and the reflected image display device is vertical in orientation.

2. The video communications system of claim 1 wherein the semi-reflective mirror is aligned at 45 degrees to a horizontal, the second mirror is aligned at 45 degrees to a horizontal and the image display device positioned in a vertical orientation with the resulting double reflection of the image on the image display device appearing in a vertical orientation.

3. The video communications system of claim 1 wherein the semi-reflective mirror is aligned at an angle greater than 45 degrees to a horizontal, the second mirror is aligned at an angle greater than 45 degrees to a horizontal and the image display device is positioned in a vertical orientation with the resulting double reflection of the image on the image display device appearing in a vertical orientation.

4. The video communications system of claim 1 wherein the semi-reflective mirror is aligned at an angle greater than 45 degrees to a horizontal, the second mirror is aligned at an angle greater than 45 degrees to a horizontal and the image display device is positioned at an angle other than 90 degrees with the resulting double reflection of the image on the image display device appearing in a vertical orientation.

5. The video communication system of claim 1 wherein a light is positioned at the top of the embodiment for illuminating the front of a presenter,

6. The video communications system of claim 1 wherein the embodiment is placed on a table or desk with the camera approximately at the eye level of a seated presenter.

7. The video communications system of claim 1 wherein the embodiment is placed on the floor with the camera approximately at the eye level of a seated or standing presenter.

8. The video communications system of claim 1 wherein an image display device is positioned behind the presenter to be within the angle of view of the camera to appear as a backdrop behind the presenter in the transmitted video.

9. The video communications system of claim 1 wherein a backlit or front lit green screen is positioned behind the presenter to be within the view of the camera for the purpose of performing a Chroma Key function of the backdrop of the transmitted video image.

10. The video communications system of claim 1 wherein a front lit or backlit panel is positioned behind the presenter to be within the view of the camera to appear as a backdrop for the transmitted video.

11. The video communications system of claim 1 wherein the camera captures an image at the vertical plane of the presenter at a height that is approximately equal to the height of an image display device that will display the transmitted video to achieve the display of a life-size image of the presenter.

12. The video communication system of claim 1 wherein the image display device displays an image of the receiving location with one or more people to participate in a two-way video communication in real time.

13. The video communication system of claim 1 wherein the image display device displays text for the presenter to read while on camera for recording or broadcasting with the presenter appearing to have aligned eye contact for the audience viewing the video.

14. A portable video communications system for capturing the image of a presenter to have a perceived eye contact when displayed at a receiving location to be viewed by one or more people comprising:
A camera positioned at a height approximately at the eye level height of a presenter within an observation zone and angled with a field of view to capture the image of the said presenter within the observation zone;
A semi-reflective mirror positioned between the camera and the presenter in the observation zone and angled to reflect the area below said semi-reflective mirror as viewed by the presenter with a mechanism for folding semi-reflective mirror in parallel orientation with a vertical portable enclosure when not in use;
a light-absorbing panel positioned above said semi-reflective mirror and located in the reflected view of said camera with a mechanism for folding the light-absorbing panel in parallel orientation with a vertical portable enclosure when not in use;
a second mirror positioned below said semi-reflective mirror and within the reflected view of said presenter with said second mirror angled to reflect the area under said camera with a mechanism for folding the second mirror in a parallel orientation with a vertical portable enclosure when not in use;
an image display device positioned below said camera within a portable enclosure and within the reflected view of said presenter as seen reflected off the semi-reflective mirror and as a second reflection off the second mirror;
The angles of the semi-reflected mirror, the second mirror and the image display device may be set so that the resulting double reflection appears behind the semi-reflective mirror in the eye level line of sight with the camera and the reflected image display device may be vertical in orientation.
